(19) United States
(12) Patent Application Publication
(10) Pub. No.: US 2025/0384385 A1
(43) Pub. Date: Dec. 18, 2025

(54) INFORMATION PROCESSING SYSTEM, INFORMATION PROCESSING DEVICE, INFORMATION PROCESSING METHOD, AND PROGRAM

(71) Applicant: AERONEXT INC., Tokyo (JP)

(72) Inventors: Shuji KAWAI, Tokyo (JP); Tadanari HIGUCHI, Gifu (JP); Keisuke TOJI, Tokyo (JP); Takuya HORI, Tokyo (JP)

(21) Appl. No.: 18/879,251

(22) PCT Filed: Jun. 28, 2023
(86) PCT No.: PCT/JP2023/024024

§ 371 Date: Dec. 27, 2024

(30) Foreign Application Priority Data
Jun. 30, 2022 (JP) 2022-105548

(51) Int. Cl. G06Q 10/0835

(52) U.S. Cl. CPC G06Q 10/0835

(57) ABSTRACT

An information processing system includes: a communication unit that notifies a service provider terminal used by a candidate for a service provider being a provider of a service of collection and transportation of a package and estimated to be capable of providing a service of collection and transportation of the package in accordance with a condition on collection and transportation of the package by another different transportation means, of an offer for the service, a control unit that approves the service provider candidate as the service provider, and a screen generation unit that generates notification of information on the service of collection and transportation of the package.

### FIELD

The present invention relates to an information processing system, an information processing device, an information processing method, and a program.

### BACKGROUND

In recent years, demand for physical distribution, such as package delivery or collection, has been increasing rapidly because of the spread of electronic commerce, changes in the social environment, and the like. With the rapid increase in the demand, the labor shortage in physical distribution has become a fundamental problem in stably maintaining the physical distribution function itself. Thus, various techniques for efficient package delivery or collection have been considered. For example, Patent Literature 1 discloses a technique that, in physical distribution of home-delivery goods, acquires the package capacity of each of one or a plurality of loop-line transportation services circulating through three bases and determines whether to change the operation plans of the loop-line transportation services on the basis of the acquired package capacity. Such a conventional transportation system employs a hub-and-spoke system in which packages are temporarily collected into a base, such as a large warehouse, and the packages are transported from the base to various directions.

Furthermore, in recent years, as a new bearer of physical distribution, for example, food delivery services in which users use smartphones and the like to request transportation of food items have started to utilize providing of services of the transportation by workers taking on one-time jobs via the Internet (so-called gig workers).

### CITATION LIST

### Patent Literature

Patent Literature 1: Japanese Patent Application Laid-open No. 2020-52525

### SUMMARY

### Technical Problem

Unfortunately, a technique contributing to increased efficiency of package delivery or collection is desired.

Thus, the present invention has been made in light of the foregoing, and an object of the present invention is to provide a novel and improved information processing system, information processing device, information processing method, and program that can contribute to increased efficiency of package delivery or collection.

### Solution to Problem

To solve the above problem, according to an aspect of the present invention, an information processing system is provided that includes a communication unit that notifies a service provider terminal used by a service provider candidate, of an offer for a service provider in accordance with a condition on a service of collection and transportation of a package by another different transportation means, the service provider being capable of providing the service of collection and transportation of the package, a control unit that approves a service provider candidate capable of providing the service of collection and transportation of the package as a service provider, and a screen generation unit that generates notification of information on the collection and transportation of the package.

Furthermore, according to the present invention, an information processing device is provided that includes a communication unit that notifies a service provider terminal used by a service provider candidate, of an offer for a service provider in accordance with a condition on a service of collection and transportation of a package by another different transportation means, the service provider being capable of providing the service of collection and transportation of the package, a control unit that approves a service provider candidate capable of providing the service of collection and transportation of the package as a service provider, and a screen generation unit that generates notification of information on the collection and transportation of the package.

Furthermore, according to the present invention, an information processing method is provided that is executed by a computer and that includes notifying a service provider terminal used by a service provider candidate, of an offer for a service provider in accordance with a condition on a service of collection and transportation of a package by another different transportation means, the service provider being capable of providing the service of collection and transportation of the package, approving a service provider candidate capable of providing the service of collection and transportation of the package as a service provider, and generating notification of information on the collection and transportation of the package.

Furthermore, according to the present invention, a program is provided that causes a computer to function as an information processing device including a communication unit that notifies a service provider terminal used by a service provider candidate, of an offer for a service provider in accordance with a condition on a service of collection and transportation of a package by another different transportation means, the service provider being capable of providing the service of collection and transportation of the package, a control unit that approves a service provider candidate capable of providing the service of collection and transportation of the package as a service provider, and a screen generation unit that generates notification of information on the collection and transportation of the package.

### BRIEF DESCRIPTION OF DRAWINGS

FIG. 1 is an explanatory diagram for describing an overview of an information processing system according to an embodiment.

FIG. 2 is an explanatory diagram for describing an example of delivery slots according to the present embodiment.

FIG. 3 is an explanatory diagram for describing an example of a functional configuration of an information terminal 10 according to the present embodiment.

FIG. 4 is an explanatory diagram for describing an example functional configuration of a server 30 according to the present embodiment.

FIG. 5 is an explanatory diagram for describing an example offer notification screen for a service of package collection and transportation, generated by a screen generation unit 333.

FIG. 6 is an explanatory diagram for describing an example screen for a travel route from the current position of a service provider candidate to a package collection point, generated by the screen generation unit 333.

FIG. 7 is an explanatory diagram for describing another example offer notification screen for a service of package collection and transportation, generated by the screen generation unit 333.

FIG. 8 is an explanatory diagram for describing an example screen for a travel route from a package collection point in a determined service of a service provider candidate to a package collection point relating to another service, generated by the screen generation unit 333.

FIG. 9 is an explanatory diagram for describing another example offer notification screen for a service of package collection and transportation, generated by the screen generation unit 333.

FIG. 10 is an explanatory diagram illustrating an example internal configuration of a holding device 20 according to the present embodiment.

FIG. 11 is a first sequence diagram for describing example operation of the information processing system according to the present embodiment.

FIG. 12 is a second sequence diagram for describing example operation of the information processing system according to the present embodiment.

FIG. 13 is an explanatory diagram for describing an example of a hardware configuration of the server according to the present embodiment.

### DESCRIPTION OF EMBODIMENTS

The contents of an embodiment of the present invention will be listed and described. An information processing system and the like according to the embodiment has the following configurations.

### Item 1

An information processing system including:
a communication unit that notifies a service provider terminal used by a service provider candidate, of an offer for a service provider in accordance with a condition on a service of collection and transportation of a package by another different transportation means, the service provider being capable of providing the service of collection and transportation of the package;
a control unit that approves a service provider candidate capable of providing the service of collection and transportation of the package as a service provider; and
a screen generation unit that generates notification of information on the collection and transportation of the package.

### Item 2

The information processing system according to item 1, in which
the control unit acquires position information and information on providing schedule status of a determined service of the service provider candidate, from the service provider terminal, and
the control unit determines a transmission destination of notification of the offer by the communication unit based on the position information of the service provider candidate, the providing schedule status of the service, and travel means, preliminarily stored in a storage unit, of the service provider candidate.

### Item 3

The information processing system according to item 2, in which the information on the service of the collection and transportation of the package includes current-position-as-origin task information being information on the service estimated, by the control unit, to be capable of being provided by the service provider candidate in accordance with at least any one or more of a distance to a package collection point with a current position of the service provider candidate being an origin, a travel route, and a travel time.

### Item 4

The information processing system according to item 3, in which the information on the service of the collection and transportation of the package includes determined-task-as-origin information being information on the service estimated, by the control unit, to be capable of being provided by the service provider candidate in accordance with at least any one or more of a distance to a package collection point in another service with a package collection point or a delivery destination in the determined service of the service provider being an origin, a travel route, and a travel time.

### Item 5

The information processing system according to item 4, in which
the control unit generates one or more transportation plans including a transportation route for the package of the other different transportation means and transportation means to the package collection point,
the control unit approves a user determined to be the service provider candidate as the service provider based on acceptance of the offer by the user, and
upon the approval of the service provider, the control unit selects and approves one transportation plan among the transportation plans.

### Item 6

The information processing system according to item 4, in which
the control unit acquires a service providable condition indicating a condition on which each user is capable of providing a service, and
the control unit selects a user satisfying the service providable condition among the users determined to be the candidates and approves the user as the service provider.

### Item 7

The information processing system according to item 5, in which the information on the service of the collection and transportation of the package includes irregular task information being information on notification, for a service provider candidate, of an offer for a service of collection and transportation of the package in a transportation section in the transportation plan generated by the control unit, transportation by the other different transportation means being planned in the transportation section.

### Item 8

The information processing system according to item 7, in which the irregular task information is information on notification of an offer for a service of collection and transportation of the package based on a transportation request in which time for collection or delivery is not designated by a transportation client of the package or a transportation request with a certain amount or more of time remaining from current time to designated time of delivery of the package.

### Item 9

The information processing system according to item 8, further including an operation display unit that displays the notification of the offer, and receives application operation of the user for the notification of the offer.

### Item 10

The information processing system according to item 9, further including an authentication unit that performs authentication processing of determining whether a request of package collection authentication being authentication of collection of the package by the service provider is a request from the service provider approved by the control unit.

### Item 11

The information processing system according to item 10, in which the control unit performs such control that, when the authentication unit determines that the request of the package collection authentication of the package is a request from the service provider for the package, the package becomes possible to be carried away from a holding device holding the package.

### Item 12

The information processing system according to item 11, in which
the holding device is an unmanned vehicle, and
when the authentication unit determines that the request of the package collection authentication of the package is a request from the approved service provider for the service of the collection and delivery of the package, the control unit performs such control that the package becomes possible to be carried away from the unmanned vehicle.

### Item 13

The information processing system according to item 11, in which the holding device holds the package released from an unmanned vehicle.

### Item 14

The information processing system according to item 11, in which the holding device includes
the authentication unit, and
an authentication communication unit that receives information on the authentication from the service provider terminal.

### Item 15

The information processing system according to item 10, in which
the communication unit receives identification information transmitted from the service provider terminal, and
the authentication unit performs authentication based on the identification information.

### Item 16

The information processing system according to item 15, in which the authentication unit performs authentication of collection of the package by the service provider in response to a request of authentication from the service provider terminal based on identification information relating to a holding device holding the package.

### Item 17

The information processing system according to item 10, in which, when the authentication unit performs the package collection authentication for the service provider, the control unit approves start of service providing of the collection and delivery of the package by the service provider.

### Item 18

The information processing system according to item 17, in which
the communication unit receives identification information transmitted from a recipient terminal used by a recipient of the package at a delivery destination of the package, and
the authentication unit performs authentication based on the identification information in response to an authentication request of handing-over of the package from the service provider terminal.

### Item 19

The information processing system according to item 18, in which, when the authentication unit authenticates the handing-over of the package by the service provider, the control unit approves completion of service providing of the collection and delivery of the package by the service provider and completion of delivery of the package to the delivery destination.

### Item 20

An information processing device including:
a communication unit that notifies a service provider terminal used by a service provider candidate, of an offer for a service provider in accordance with a condition on a service of collection and transportation of a package by another different transportation means, the service provider being capable of providing the service of collection and transportation of the package;
a control unit that approves a service provider candidate capable of providing the service of collection and transportation of the package as a service provider; and
a screen generation unit that generates notification of information on the collection and transportation of the package.

### Item 21

An information processing method executed by a computer, the information processing method including:
notifying a service provider terminal used by a service provider candidate, of an offer for a service provider in accordance with a condition on a service of collection and transportation of a package by another different transportation means, the service provider being capable of providing the service of collection and transportation of the package;
approving a service provider candidate capable of providing the service of collection and transportation of the package as a service provider; and
generating notification of information on the collection and transportation of the package.

### Item 22

A program causing a computer to function as an information processing device including:
a communication unit that notifies a service provider terminal used by a service provider candidate, of an offer for a service provider in accordance with a condition on a service of collection and transportation of a package by another different transportation means, the service provider being capable of providing the service of collection and transportation of the package;
a control unit that approves a service provider candidate capable of providing the service of collection and transportation of the package as a service provider; and
a screen generation unit that generates notification of information on the collection and transportation of the package.

Hereinafter, a preferable embodiment of the present invention will be described in detail with reference to the accompanying drawings. In the present specification and drawings, duplicate explanations of structural components having substantially identical functional configuration will be omitted by applying the same reference signs thereto.

Furthermore, in this specification and the drawings, a plurality of constituents having substantially the same functional configuration may be distinguished between each other while being denoted by the same reference sign followed by different numerals or alphabets in some cases. However, when there is no particular need to distinguish between the constituents having substantially the same functional configuration, each of the constituents is denoted only by the same reference sign.

### 1. Overview of Information Processing System of One Embodiment of Present Invention

One embodiment of the present invention relates to an information processing system that can contribute to increased efficiency of package delivery or collection. To describe in more detail, according to the information processing system of the one embodiment of the present invention, a more efficient transportation system including transportation by transportation means, such as an unmanned vehicle, and a service provider, such as a gig worker, instead of or in addition to transportation on a hub-and-spoke system like a conventional transportation system can be achieved. Furthermore, according to the present invention, convenience to the service provider providing a service of package collection and transportation can be improved.

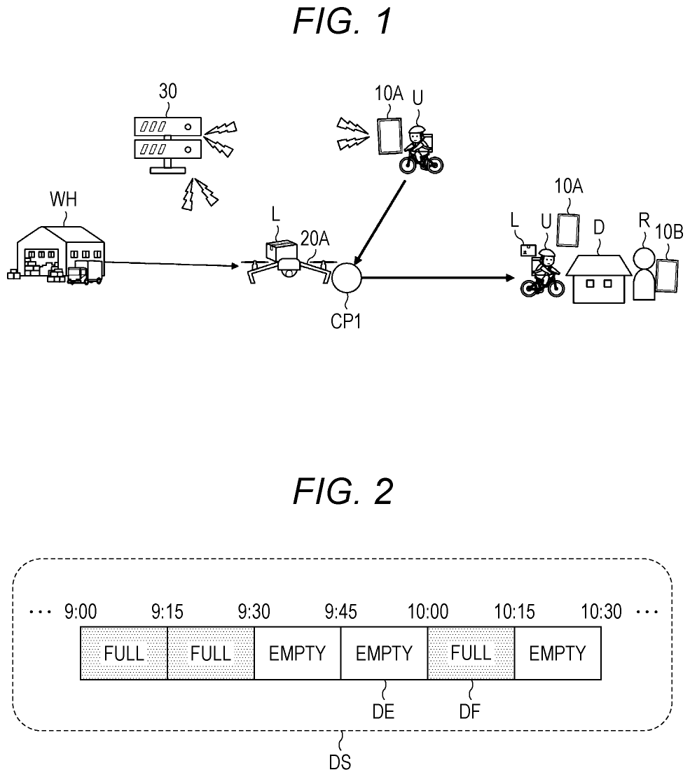

FIG. 1 is an explanatory diagram for describing an overview of the information processing system according to the present embodiment. As illustrated in FIG. 1, the information processing system of the present embodiment includes information terminals 10, a holding device 20, and a server 30. The information terminals 10, the holding device 20, and the server 30 are configured to be communicable with each other via a network.

### (Information Terminal 10)

The information terminal 10 is a terminal used by parties involved in services related to delivery or collection. For example, the information terminal 10 may be any of various kinds of terminals such as a tablet terminal, a smartphone, a cellular phone, a personal handy-phone system (PHS), a personal digital assistant (PDA), a personal computer (PC), or the like.

Furthermore, the information terminals 10 include a service provider terminal 10A used by a service provider U providing a service of collecting a package L delivered by another different transportation means to a designated package collection point and transporting the package L to a delivery destination D. For example, the service provider U may use the service provider terminal 10A to browse notification received from the server 30 and relating to an offer for service providing.

The service provider terminal 10A receives the notification of an offer relating to providing a service of collection and transportation of the package L, from the server 30. The service provider U can browse the above offer notification by operating the service provider terminal 10A. Furthermore, the service provider U can accept the above offer by operating the service provider terminal 10A. When the service provider U performs operation to accept the offer (for example, operates an acceptance button displayed on a screen) on the service provider terminal 10A, the service provider terminal 10A notifies the server 30 that the service provider U has accepted the offer.

Furthermore, the service provider terminal 10A has a function to display various pieces of information on the above offer for the service provider U under control of the server 30. For example, the service provider terminal 10A can display information of the position of the package collection point for the service determined to be provided, the travel route from the current position of the service provider U or a waypoint, and the like, for the service provider U.

Moreover, the service provider terminal 10A requests the server 30 to perform authentication of package collection (hereinafter, package collection authentication) when the service provider U collects the package from the holding device 20, on the basis of operation of the service provider U. If determining the success of the authentication, the server 30 controls the holding device 20 to make the package held by the holding device 20 possible to be carried away and approves that the service provider U has started the service providing (hereinafter, also referred to as a task). Hereinafter, the package collection authentication is also referred to as authentication of the start of a determined service of a service provider U.

Furthermore, the service provider terminal 10A requests the server 30 to perform authentication of package handing-over (hereinafter, package handing-over authentication) when the service provider U hands over the package L to a recipient R, on the basis of operation of the service provider U. At this time, the service provider terminal 10A may display an image for authentication in response to a reply from the server 30 to the authentication request. Upon receiving identification information read from the image for authentication from a recipient terminal 10B, the server 30 uses the identification information to perform authentication processing of the package handing-over authentication. For example, the server 30 may perform the authentication processing by checking whether a package ID, being an example of the identification information, of the package L and a service provider ID of the service provider U are associated IDs in a database in the server 30. If determining that the package handing-over authentication has succeeded, the server 30 may approve that the task for the package L has been completed by the service provider U. Hereinafter, the package handing-over authentication is also referred to as authentication of the completion of service providing. Note that the package handing-over authentication may be performed by the server 30 in response to handing-over completion operation (for example, operation on a completion button displayed on a screen) of the service provider U on the service provider terminal 10A.

The information terminals 10 also include the recipient terminal 10B used by the recipient R receiving the package at the delivery destination of the package L. For example, the recipient R may use the recipient terminal 10B to read the image for authentication displayed on a screen of the service provider terminal 10A in accordance with instructions from the service provider U or displayed on the service provider terminal 10A used by the service provider U. The server 30 may receive the identification information acquired by reading the above image for authentication from the recipient terminal 10B. Furthermore, the server 30 may use the received identification information to perform authentication processing of the package handing-over authentication.

Note that, in the example illustrated in FIG. 1, the information terminals 10 included in the information processing system of the present embodiment are two, the service provider terminal 10A and the recipient terminal 10B; however, the number of the information terminals 10 is not limited to two. The information processing system of the present embodiment may include two or more information terminals 10.

### (Holding Device 20)

The holding device 20 is a device capable of holding a package. There are no particular limitations on the holding device 20 as long as a package can be held. The holding device 20 may be, for example, an unmanned vehicle that travels under autonomous control using input information on the positions of two points such as the start point (for example, the start position of transportation of the package L or the start position of travel of the holding device 20) and the end point (for example, the receiving location of the package L) of package transportation or the positions of three or more points additionally including a relay point (for example, the collection location of the package L in the case of transportation involving collection of the package L) and a return point (for example, the same position as the start position of travel of the unmanned vehicle 10, a different standby position, or the like). Alternatively, the holding device 20 may be an unmanned vehicle that travels through remote operation using operation information remotely input for operation by an administrator administering the unmanned vehicle.

The unmanned vehicle may be, for example, a drone traveling under autonomous control, an unmanned aerial vehicle (UAV) traveling through remote operation of an administrator, a vehicle traveling along a land route, such as an unmanned ground vehicle (UGV), or a vessel traveling on the water, for example, along a sea route or a river route. In the example illustrated in FIG. 1, the holding device 20A is a drone.

Alternatively, the unmanned vehicle may be a mobile body that can travel along at least two or more routes among a land route, a water route, and an air route.

Alternatively, the holding device 20 may be a delivery box installed outdoors and capable of accommodating a transported package. Note that the delivery box may hold a package released from the unmanned vehicle and preferably includes a mechanism for automatically taking the package into the delivery box especially for the unmanned vehicle 10B. Alternatively, the holding device 20 may be a container unit transported simultaneously with a package and detached from the unmanned vehicle or a container device with an electronic lock containing a package. If it is determined that the authentication performed by the server 30 in response to an authentication request received from the service provider terminal 10A has succeeded, the holding device 20 makes the held package possible to be carried away on the basis of control at the server 30. If the delivery box has an electronic lock function, the container unit containing the package may be unlocked on the basis of information on unlocking transmitted from the server 30 to the service provider terminal 10A. The information on unlocking may be an unlocking code, and the service provider may directly operate an accommodation box to input the unlocking code or the service provider terminal 10A may input the unlocking code through communication.

### (Server 30)

The server 30 is an example information processing device and has a function to receive a request for package delivery or collection (hereinafter, transportation request) from a client and to generate a transportation plan including information of transportation means for the package, a transportation route, and the like. The server 30 also has a function to manage operation of each transportation means, such as the holding device 20A, on the basis of the generated transportation plan. For example, the server 30 may be a general-purpose computer, such as a workstation or a PC, or a cloud server. Note that there are no particular limitations on the method of receiving the transportation request at the server 30. For example, the server 30 may receive a transportation request by communicating with a smartphone used by a general consumer, an external terminal installed in a store, such as a retail shop and a restaurant, or the like, which are not illustrated in FIG. 1. Alternatively, an operator of the server 30 may input a transportation request received from a client to the server 30, so that the server 30 receives the transportation request.

Upon receiving a transportation request, the server 30 first generates the above-described transportation plan. At this time, the server 30 may generate a plurality of the transportation plans from the start position of transportation of the package L to the end point with a plurality of mutually different combinations of transportation means, transportation routes, and time periods. The transportation means may be, for example, the drone, UAV, or UGV that realizes the holding device 20. Alternatively, the transportation means may be a transporter using a mobile body, such as a vehicle (for example, a passenger vehicle, a truck, such as a light truck and a light van, a motorcycle, a bicycle, a scooter, or the like) to carry a package. Furthermore, while a deliverable point being the final point where each transportation means can deliver is a package collection point CP, the server 30 generates the transportation plan from a warehouse WH to the package collection point CP. At this time, for a section from the package collection point CP to the delivery destination D, the server 30 may make an offer for a service of collection and transportation of the package L by a service provider U. In this way, the server 30 can generate the transportation plan with a combination of delivery to the package collection point CP (relay point) using transportation means other than service providers and package collection and transportation from the package collection point CP by a service provider. Note that, if the deliverable point of each transportation means is the delivery destination of the package L, the server 30 may generate a transportation plan without using a service of package collection and transportation by a service provider. To be more specific, the server 30 may designate transportation means from the start point of delivery of the package L to the delivery destination being the end point, only among other transportation means, such as a drone, a UAV, a UGV, or a transporter, different from that for a service of the service provider. Furthermore, the start point is not limited to a warehouse and may be, for example, a store, such as a retail shop and a restaurant.

In the example illustrated in FIG. 1, the server 30 generates a transportation plan in which the holding device 20A delivers the package L in a section from the warehouse WH to the package collection point CP1. Furthermore, the server 30 designates the deliverable point where the holding device 20A can deliver as the package collection point CP1. In the example illustrated in FIG. 1, the package collection point CP1 is a point (drone stand) where the holding device 20A can take off and land and the package L can be handed over.

The server 30 also has a matching function to determine a service provider candidate capable of providing a service of collecting and transporting the package L from the package collection point CP1. The server 30 determines the service provider candidate from among a plurality of preliminarily registered users. Furthermore, the server 30 notifies the user determined to be the service provider candidate, of an offer for the service providing.

The service provider U can browse the above offer notification received from the server 30 on the service provider terminal 10A. Furthermore, the service provider U can accept (apply for) the offer by operating the service provider terminal 10A.

If any user accepts the offer for the service providing, the server 30 can select and approve a transportation plan with a combination including package collection and transportation by a service provider, among the generated transportation plans.

If approving one transportation plan, the server 30 manages various schedules relating to the delivery or collection in the transportation plan, such as designation of transportation means and reservation of a time slot for the transportation plan. For example, the server 30 may register a transportation schedule for the delivery or collection of the package L in a transportation slot of the transporter or the holding device 20 transporting the package L. Note that, in this specification, the transportation slot indicates a time period in which each transportation means, such as a transporter or the holding device 20, can provide transportation.

FIG. 2 is an explanatory diagram for describing an example of the delivery slots according to the present embodiment. For example, the daily transportation plan DS of the holding device 20 (for example, the unmanned vehicle) or a transporter is divided into predetermined transportation slots (for example, every 15 minutes), and the holding device 20A or the transporter transports the package L registered in each transportation slot at the time indicated by the transportation slot. Such a combination of the transportation plan DS and the transportation slots may be set for each of a plurality of transportable point (package collection point) candidates.

For example, the transportation plan DS set for a transportable point (for example, the package collection point CP illustrated in FIG. 1 or the like) includes two types of transportation slots, a “full” transportation slot (hereinafter, referred to as a full slot DF) indicating that the transportation schedule of the holding device 20A or a transporter is already booked and an “empty” transportation slot (hereinafter, referred to as an empty slot DE) indicating that the transportation schedule of the holding device 20A or a transporter is free.

Furthermore, the server 30 generates transportation instruction information for instructing the holding device 20A or the transporter on information of the transportation destination, the transportation route, or the like on the basis of the approved transportation plan. The server 30 may directly transmit the generated transportation instruction information to the holding device 20A or may transmit the generated transportation instruction information to a transporter terminal (not illustrated) used by the transporter. The holding device 20A or the transporter performs the work of delivery and collection of the package L in accordance with the transportation instruction information. This allows the server 30 to, if approving a service provider capable of providing a service of collecting and transporting the package in a section beyond the deliverable point of each transportation means, execute the transportation of the package L with a combination of the service providing of the service provider and another transportation means, such as the holding device 20A. Thus, more efficient transportation using various transportation means can be achieved.

The overview of the information processing system according to the present embodiment is described heretofore. Next, example functional configurations of the information terminal 10, the server 30, and the holding device 20 of the present embodiment will be described.

### 2. Example Functional Configuration

### <2-1. Information Terminal 10>

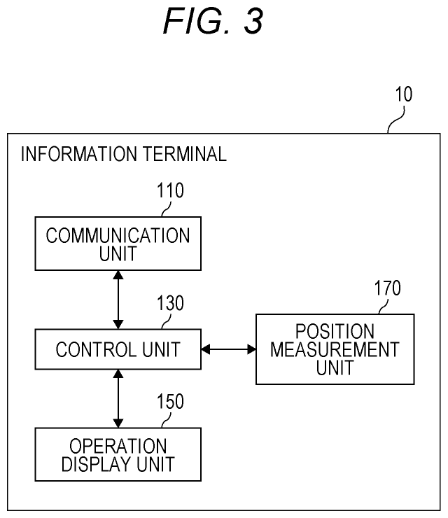

FIG. 3 is an explanatory diagram for describing an example of the functional configuration of the information terminal 10 according to the present embodiment. As illustrated in FIG. 3, the information terminal 10 of the present embodiment includes a communication unit 110, a control unit 130, an operation display unit 150, and a position measurement unit 170.

### (Communication Unit 110)

The communication unit 110 performs various communications with the server 30. For example, the communication unit 110A of the service provider terminal 10A receives notification of an offer for service providing from the server 30. Furthermore, the communication unit 110A transmits notification that the service provider U has accepted the above offer to the server 30 on the basis of operation of the service provider U. The communication unit 110A also transmits an authentication request to the server 30. At this time, the authentication request can include the identification information used for the authentication processing at the server 30. The identification information may be a service provider ID capable of uniquely identifying the service provider U using the service provider terminal 10A and may be identification information on the holding device 20, which will be described later.

Furthermore, the communication unit 110B of the recipient terminal 10B reads an image for authentication on the operation display unit 150A of the service provider terminal 10A presented at the time of package handing-over from the service provider U and then transmits notification that the image for authentication has been read and the identification information read from the image for authentication, to the server 30. The identification information may be, for example, a package ID of the package L of which the addressee is the recipient R.

### (Control Unit 130)

The control unit 130 controls overall operation of the information terminal 10. For example, the control unit 130 controls transmission and reception of various pieces of information at the communication unit 110. For example, the control unit 130A of the service provider terminal 10A causes the communication unit 110A to transmit information on the execution status, input from the operation display unit 150A, of a currently determined service of the service provider U, to the server 30.

### (Operation Display Unit 150)

The operation display unit 150 has a function as an operation unit capable of receiving various operations of the user of the information terminal 10, such as the service provider U or the recipient R. For example, the operation display unit 150A receives input operation of information on the execution status of a service of collection or transportation of the package L by the service provider U. The service provider U can respond to offer notification for a service by operating the operation display unit 150A. The operation to respond to the offer notification for a service may be, for example, operation of pressing an application button displayed on the operation display unit 150A.

By operating the operation display unit 150A, the service provider U can also request the server 30 to perform authentication of the start of a determined service (package collection authentication) or authentication of the completion of a service (package handing-over authentication). By operating the operation display unit 150A, the service provider U can also browse information on an offered or determined service (the position of the package collection point, the travel route, or the like).

Furthermore, the operation display unit 150B can receive reading operation on the image for authentication on the operation display unit 150A presented by the service provider U on the basis of operation of the recipient R. At this time, the recipient terminal 10B may include a camera, which is not illustrated in FIG. 3. In this case, the recipient terminal 10B may use the camera to read the identification information used for authentication from the image for authentication on the basis of operation on the operation display unit 150B.

The function of the operation display unit 150 as the operation unit can be realized by, for example, a touch panel or a keyboard. Furthermore, the function as the display unit can be achieved by a cathode ray tube (CRT) display device, a liquid crystal display (LCD), or an organic light emitting diode (OLED) device. Note that the function as the display unit and the function as the operation unit may be configured separately.

The information terminal 10 may also include a microphone, which is not illustrated in FIG. 3, and, in this case, the service provider U may use the microphone to input, by voice, the execution status of a service of delivery or collection of the package L. The information terminal 10 may further include a speaker, which is not illustrated in FIG. 3, and, in this case, the service provider U may confirm information on a service by voice output from the speaker.

### (Position Measurement Unit 170)

The position measurement unit 170 has a function to calculate the absolute or relative position of the information terminal 10. For example, the position measurement unit 170 may detect the current position on the basis of an externally acquired signal. To be specific, for example, a global navigation satellite system (GNSS) that receives radio waves from an artificial satellite to detect the current position where the information terminal 10 is located may be used. Alternatively, other than a GNSS, a method of detecting the position using Wi-Fi (registered trademark), Bluetooth (registered trademark), transmission to and reception from a cellular phone, a PHS, a smartphone, or the like, short-distance communication, or the like may be used. Furthermore, the position measurement unit 170 may estimate information indicating a relative change in the position of the information terminal 10 on the basis of a result of detection at an acceleration sensor, an angular velocity sensor, or the like.

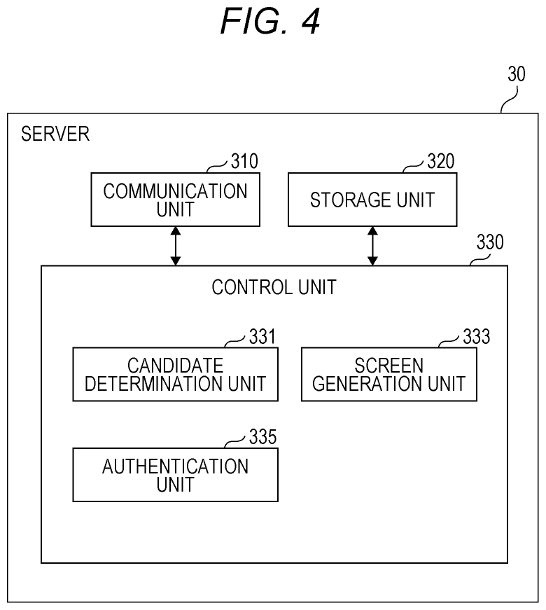

An example functional configuration of the information terminal 10 of the present embodiment has been described with reference to FIG. 3. Next, an example functional configuration of the server 30 of the present embodiment will be described with reference to FIG. 4.

### <2-2. Server 30>

FIG. 4 is an explanatory diagram for describing an example functional configuration of the server 30 of the present embodiment. As illustrated in FIG. 4, the server 30 of the present embodiment includes a communication unit 310, a storage unit 320, and a control unit 330.

The control unit 330 includes an arithmetic unit, such as a central processing unit (CPU) or a graphics processing unit (GPU), and its function can be realized by extracting and executing a program stored in a read only memory (ROM) on a random access memory (RAM). At this time, a computer-readable recording medium recording the program can also be provided. Alternatively, these blocks may be configured by dedicated hardware or may be realized by a combination of a plurality of pieces of hardware.

Data required for computation at the arithmetic unit is stored in the storage unit 320 as appropriate. The storage unit 320 may be configured by a memory, such as a RAM, a hard disk drive, or a flash memory.

### (Communication Unit 310)

The communication unit 310 performs various communications with the information terminal 10 and an external terminal, such as the holding device 20. For example, the communication unit 310 transmits offer notification for a service to the service provider terminal 10A under control of the control unit 330. Furthermore, the communication unit 310 receives notification that the service provider U has accepted the offer for the service from the service provider terminal 10A. The communication unit 310 also receives position measurement information of the current position of the service provider U and the like, information of the current task execution status input to the service provider terminal 10A through operation of the service provider U, and an authentication request, from the service provider terminal 10A. Furthermore, the communication unit 310 receives a transportation request by communicating with the aforementioned smartphone used by a general consumer (client) or external terminal installed in a store or the like.

### (Storage Unit 320)

The storage unit 320 holds software and various pieces of data. For example, the storage unit 320 holds preliminarily registered information of a user capable of providing a service of package collection and transportation. The user information includes, for example, information of travel means used by each service provider U and an area where a service can be provided.

The storage unit 320 also holds various pieces of information on generation of the transportation plan. For example, the storage unit 320 holds information on each transportation means, the transportable position of each transportation means, the availability of each transportable position, the availability of transportation slots of each transportation means, and transportation requests (for example, position information of the address of the transportation destination and the like, the type and number of the package L, and the like included in a transportation request).

Furthermore, the storage unit 320 stores the service provider ID being identification information for uniquely identifying the service provider U using the service provider terminal 10A.

The storage unit 320 also stores information on the package L. The information on the package L includes, for example, the identification information of the package L, the scheduled arrival time of the package L, whether the package L is frozen, whether the package L is a careful-handling object that should be handled with care, such as an object that should not be turned over, that must not be stacked, that is perishable, or that is fragile, the transportation means for the package L, information of the recipient R being the addressee of the package L, and the like.

The storage unit 320 also stores the database of the identification information of the package L and information on the service provider U approved as the service provider providing a service of collection and transportation of the package L. For example, in the database stored in the storage unit 320, the service provider ID of the service provider U associated with the package ID being the identification information of the package L may be linked. The association between the package ID and the service provider ID in the storage unit 320 may be performed under control of the control unit 330 when the control unit 330 approves a service provider for a service of collection and transportation of a package. Furthermore, an authentication unit 335, which will be described later, performs authentication processing of the package collection authentication or the package handing-over authentication on the basis of the above-described database held by the storage unit 320.

### (Control Unit 330)

The control unit 330 controls overall operation of the server 30. The control unit 330 performs such control that, for example, the communication unit 310 transmits offer notification for a service to the service provider terminal 10A. This control unit 330 has a function to, if the communication unit 310 receives a transportation request for a package L, generate one or more transportation plans for transportation of the package L.

The control unit 330 also performs such control that the communication unit 310 transmits offer notification for a service to users determined to be service provider candidates by a candidate determination unit 331, which will be described later. The control unit 330 acquires the position information on the service provider candidate and information on the providing schedule status (including, for example, the distance between the delivery destination and the current position, the time required, and the like) of a determined service of the service provider candidate, from each of the service provider terminals 10A used by the users determined to be the service provider candidates via the communication unit 310. Furthermore, the control unit 330 determines the transmission destination of the offer notification on the basis of the position information and service providing schedule status of the service provider candidates and travel means of the service provider candidates held by the storage unit 320.

For example, the control unit 330 may determine a service provider candidate estimated to be capable of providing a service in accordance with at least any one or more of the distance to the package collection point with the current position of the service provider candidate being the origin, the travel route, and the travel time, as a notification destination of the offer for the service. Hereinafter, the information on a service estimated to be capable of being provided by a service provider candidate with the current position of the service provider candidate as the origin is referred to as current-position-as-origin task information.

Alternatively, the control unit 330 may determine a service provider candidate estimated to be capable of providing a service in accordance with at least any one or more of the distance to the package collection point in another service with either of the package collection point and the delivery destination in a determined service of the service provider being the origin, the travel route, and the travel time, as a notification destination of the offer for the service. In other words, the control unit 330 calculates the estimation position of the service provider at each time from information of the package collection point, package collection time period, delivery destination, and the like in a determined task of the service provider. The control unit 330 estimates whether the service provider can provide a service for a task different from the determined task on the basis of the calculated estimation position. The control unit 330 then regards the service provider estimated to be capable of providing the service for the different task as a service provider candidate for the different task and notifies the candidate of the offer for the different task. Hereinafter, the information on another service estimated to be capable of being provided by a service provider candidate with either of the package collection point and the delivery destination in a determined service of the service provider candidate as the origin is referred to as determined-task-as-origin information.

Furthermore, for a section where package collection and transportation by transportation means, such as a transporter or the holding device 20 like a drone, is planned in the above generated transportation plan, if a predetermined condition is satisfied, the control unit 330 may notify a service provider candidate of an offer for a service of the package collection and transportation in the section.

The predetermined condition may be that, for example, the transportation request relating to the above transportation plan is a transportation request in which the time designation information of collection or delivery is not set by the client. Alternatively, the predetermined condition may be that the transportation request relating to the above transportation plan is a transportation request with a certain amount or more of time remaining from the current time when the communication unit 310 receives the transportation request until the designated time of package delivery. Alternatively, if the predetermined condition is that the delivery destination position included in the transportation request is outside a predetermined range from the position where the holding device 20 or the transporter starts the transportation (for example, the current position of the warehouse WH or the holding device 20, the current area in charge, or the like) (that is, outside the transportation area for the holding device 20 or the transporter), a transportation plan with a combination of delivery to a deliverable point (relay point) using transportation means and package collection and transportation by a service provider U from the deliverable point to the delivery destination may be generated. In this case, the procedure may proceed to step 109 without going through step S107. Hereinafter, the information on a service of package collection and transportation based on a transportation request satisfying the above predetermined condition is referred to as irregular task information.

A service provider takes charge of a service relating to such irregular task information, so that, when there is no time to spare, transportation by a service provider can be used even in a transportation section for which transportation means, such as a transporter or the holding device 20 like a drone, is usually selected. Thus, options for transportation means in the transportation section can be broadened. This enables increased efficiency of package collection and transportation. Furthermore, an offer for a service relating to such irregular task information increases a labor opportunity for a service provider candidate. Thus, convenience for a service provider is also improved.

Note that example contents of the above-described current-position-as-origin task information, determined-task-as-origin information, and irregular task information will be described in detail later in the description of example offer notification generated by a screen generation unit 333.

The control unit 330 also has a function to, on the basis of the fact that a user determined to be a service provider candidate has accepted an offer, approve the user as the service provider. If approving one user as a service provider, the control unit 330 selects and approves one transportation plan to the transportable position for the service provider (the package collection point from the viewpoint of the service provider U) among the generated transportation plans.

If selecting and approving the one transportation plan, the control unit 330 generates transportation instruction information including information of transportation means designation and transportation slot designation on the basis of the transportation plan. Furthermore, the control unit 330 may cause the communication unit 310 to transmit the transportation instruction information to the transporter terminal used by the transporter. Alternatively, the control unit 330 may perform such control that the communication unit 310 directly communicates with the holding device 20A to transmit the above transportation instruction information. Alternatively, if there is an administrator remotely operating the holding device 20A, the control unit 330 may cause the communication unit 310 to transmit the above transportation instruction information to an information terminal (for example, a PC) used by the administrator. This allows the transportation of the package L based on the transportation plan generated and approved by the server 30.

### (Candidate Determination Unit 331)

The candidate determination unit 331 has a function to, in accordance with a condition for package collection and transportation by another transportation means different from that for a service of a service provider, determine a service provider candidate for a service of the package collection and transportation. The control unit 330 determines the service provider terminal 10A used by the user determined to be the service provider candidate by the candidate determination unit 331, as a transmission destination of the offer notification.

To describe in more detail, the candidate determination unit 331 has a function to, in accordance with conditions of the transportation means, transportation route, package collection point, package collection time period, and the like included in the above transportation plan generated by the control unit 330, determine one or more users estimated to be capable of providing the service of collection and transportation of the package L from the package collection point as service provider candidates. The candidate determination unit 331 determines the service provider candidates for the above transportation plan from among the preliminarily registered users. Hereinafter, a user in this specification refers to a person preliminarily registered as a subject capable of being a service provider candidate. User registration may be performed by transmitting information on each user input through operation of the user on the information terminal 10 to the server 30 and storing the information in the storage unit 320. Alternatively, the storage unit 320 may preliminarily hold user information.

The candidate determination unit 331 determines the users estimated to be capable of providing the service as the service provider candidates on the basis of the package collection time period at the package collection point, the position information of the users, the travel means of the candidate users, and the providing schedule status of determined services of the candidate users. The package collection time period can be determined in accordance with the availability of transportation slots of each transportation means, such as the holding device 20A, and the package collection point when the control unit 330 generates the transportation plan. Alternatively, if the transportation request of the package L includes collection of the package L, the package collection time period may be a desired collection time. Furthermore, the candidate determination unit 331 acquires the current position of each user and the providing schedule status of a determined service of the user from the information terminal 10 via the communication unit 310.

In processing of determining the service provider candidates, the candidate determination unit 331 estimates the estimation positions of the users at each time and the travel routes from the current positions of the users to the package collection point on the basis of the current positions of the users and the providing schedule status of the determined services. The candidate determination unit 331 determines the users estimated to be capable of providing the service as the service provider candidates within a predetermined maximum number on the basis of the estimated estimation positions and travel routes. At this time, the maximum number of users determined to be the candidates may be preliminarily set by the operator of the server 30.

Furthermore, if the package L is, for example, a package for which the controlled temperature range is set, such as a product requiring refrigeration, the candidate determination unit 331 may acquire a waitable time indicating a time, determined on the basis of the controlled temperature range, for which the package L can wait at the package collection point. The waitable time may be predetermined for each type of package L and held by the storage unit 320. The candidate determination unit 331 may determine a user estimated to be capable of arriving at the package collection point after an estimated arrival time of the package at the package collection point by when the waitable time lapses, as the service provider candidate.

### (Screen Generation Unit 333)

The screen generation unit 333 has a function to generate various screens. For example, the screen generation unit 333 generates notification of an offer for a service provider. The offer notification generated by the screen generation unit 333 is transmitted to the service provider terminal 10A used by the user determined to be the service provider candidate, under control of the control unit 330. Alternatively, the server 30 may include a display unit, which is not illustrated in FIG. 4, and, in this case, the offer notification may be displayed on the display unit under control of the control unit 330.

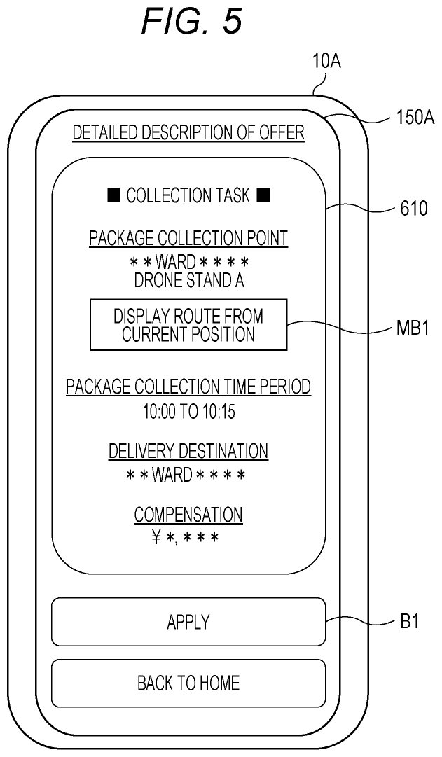

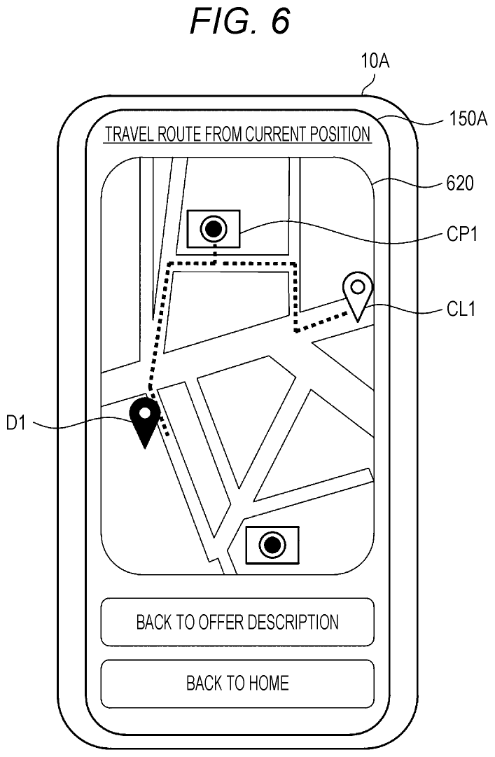

Here, with reference to FIGS. 5 and 6, example offer notification generated by the screen generation unit 333 will be described. FIG. 5 is an explanatory diagram for describing an example offer notification screen for a service of package collection and transportation, generated by the screen generation unit 333. FIG. 5 is a diagram illustrating a state where an offer notification screen 610 generated by the screen generation unit 333 is displayed on the operation display unit 150A of the service provider terminal 10A. Furthermore, the offer notification screen 610 is an example of the current-position-as-origin task information. Note that an example of each screen in a case where the service provider U illustrated in FIG. 1 is the service provider candidate will be described below.

The offer notification generated by the screen generation unit 333 may include, for example, information, such as the type of offered service (collection task or delivery task), information of the package collection point of the task, the package collection time period, the delivery destination, the compensation for the service provider candidate if accepting the service, and the like. In the example illustrated in FIG. 5, the offer notification screen 610 indicates that the type of offered service is a collection task, the package collection point is a drone stand A, and the package collection time period is from 10:00 to 10:15. The offer notification screen 610 also indicates the address of the delivery destination and the compensation.

In the example illustrated in FIG. 5, below the offer notification screen 610, a button B1 is displayed. By performing operation of pressing the button B1, the service provider U can perform response operation to the offer indicated by the offer notification screen 610.

Furthermore, in a middle section of the offer notification screen 610, a travel route display button MB1 is displayed. By performing operation of pressing the travel route display button MB1, the service provider U may browse the map and travel route from the current position of the service provider U to the package collection point in the service relating to the offer notification screen 610.

FIG. 6 is an explanatory diagram for describing an example screen for the travel route from the current position of the service provider candidate to the package collection point, generated by the screen generation unit 333. FIG. 6 is a screen to which transition is made after the service provider U performs operation of pressing the travel route display button MB1 on the offer notification screen 610 illustrated in FIG. 5.

As illustrated in FIG. 6, a travel route screen 620 is a map screen including a current position CL1, a package collection point CP1, and a delivery destination D1. The current position CL1 indicates the current position of the service provider U. Furthermore, the package collection point CP1 indicates the position of the package collection point in the service relating to the offer notification screen 610 illustrated in FIG. 5. The delivery destination D1 indicate the position of the delivery destination in the service.

In the example illustrated in FIG. 6, the travel route from the current position CL1 to the package collection point CP1 is illustrated by a dotted line. The travel route from the package collection point CP1 to the delivery destination D1 is also illustrated by a dotted line. The screen generation unit 333 generates the travel route screen 620 on the basis of the position information of the service provider U acquired from the service provider terminal 10A, the position information of the package collection point for the generated transportation plan, and the position information of the delivery destination. Furthermore, the screen generation unit 333 may update display of the current position CL1 and travel route on the travel route screen 620 in real time in accordance with a change in the position information of the service provider U. Such display of the offer notification and map information on the offer allows the service provider U to more easily determine whether to accept the offer for each service. Thus, convenience for the service provider U is improved.

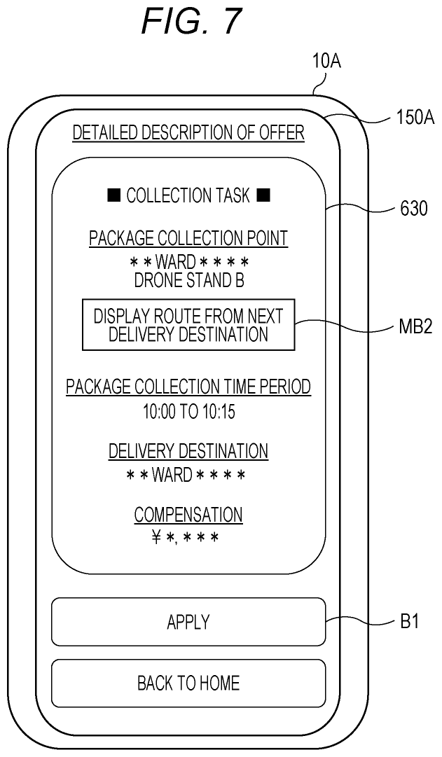

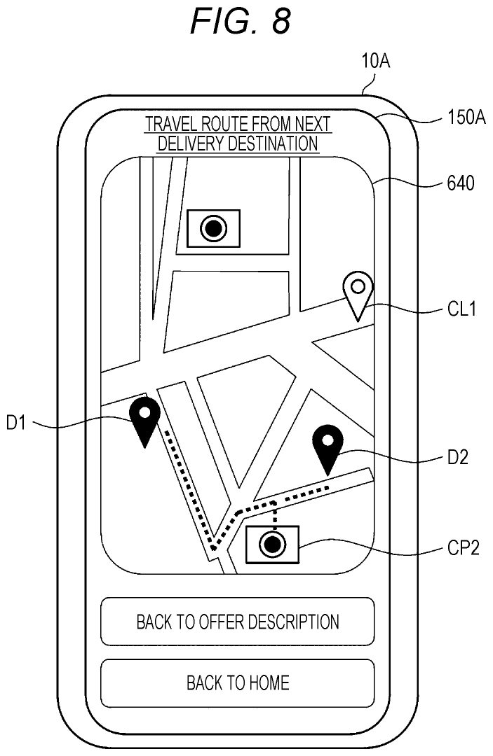

Example offer notification generated by the screen generation unit 333 has been described with reference to FIGS. 5 and 6. Next, another example offer notification generated by the screen generation unit 333 will be described with reference to FIGS. 7 and 8.

FIG. 7 is an explanatory diagram for describing another example offer notification screen for a service of package collection and transportation, generated by the screen generation unit 333. FIG. 7 is a diagram illustrating a state where an offer notification screen 630 generated by the screen generation unit 333 is displayed on the operation display unit 150A of the service provider terminal 10A. Furthermore, the offer notification screen 630 is an example of the determined-task-as-origin information.

In the example illustrated in FIG. 7, the offer notification screen 630 indicates that the type of offered service is a collection task, the package collection point is a drone stand B, and the package collection time period is from 10:00 to 10:15. The offer notification screen 630 also indicates the address of the delivery destination and the compensation.

In the example illustrated in FIG. 7, below the offer notification screen 630, the button B1 is displayed. By performing operation of pressing the button B1, the service provider U can perform operation of accepting the offer indicated by the offer notification screen 630.

Furthermore, in a middle section of the offer notification screen 630, a travel route display button MB2 is displayed. By performing operation of pressing the travel route display button MB2, the service provider U may browse the map and travel route from the package collection point in the determined task of the service provider U to the package collection point in the service relating to the offer notification screen 630.

FIG. 8 is an explanatory diagram for describing an example screen for the travel route from the package collection point in the determined service of the service provider candidate to the package collection point relating to another service, generated by the screen generation unit 333. FIG. 8 is a screen to which transition is made after the service provider U performs operation of pressing the travel route display button MB1 on the offer notification screen 630 illustrated in FIG. 7.

As illustrated in FIG. 8, a travel route screen 640 is a map screen including the current position CL1, the delivery destination D1, a package collection point CP2, and a delivery destination D2. As described with reference to FIG. 6, the current position CL1 indicates the current position of the service provider U. Furthermore, as described with reference to FIG. 6, the delivery destination D1 indicates the position of the delivery destination in the service relating to the offer notification screen 610 illustrated in FIG. 5.

The package collection point CP2 indicates the position of the package collection point in the service relating to the offer notification screen 630 illustrated in FIG. 7. Furthermore, the delivery destination D2 indicates the position of the delivery destination in the service.

In the example illustrated in FIG. 8, instead of the travel route from the current position CL1, the travel route from the delivery destination D1 to the package collection point CP2 is illustrated by a dotted line. That is, it is understood that the travel route from the position of the delivery destination relating to the determined service of the service provider U to the package collection point in another service for which the offer is newly made is displayed on the travel route screen 640. The travel route from the package collection point CP2 to the delivery destination D2 is also illustrated by a dotted line.

The screen generation unit 333 generates the travel route screen 640 on the basis of the position information of the service provider U acquired from the service provider terminal 10A, and the position information of the package collection point and the position information of the delivery destination for the generated transportation plan. Furthermore, the screen generation unit 333 may update display of the current position CL1 and travel route on the travel route screen 640 in real time in accordance with a change in the position information of the service provider U.

Such display of the offer notification relating to the determined-task-as-origin information and the travel route for the offer allows the service provider U to more easily determine whether to apply for another task in consideration of the providing schedule status of the already determined service. Thus, convenience for the service provider U is improved. This results in facilitation of application, from the service provider U, for an offer notified by the server 30, which promotes package collection and transportation utilizing various transportation means. Thus, contribution to increased efficiency of package collection and transportation is achieved.

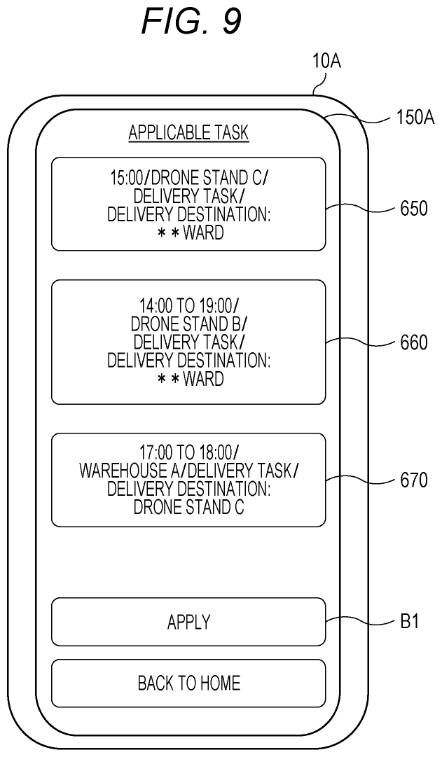

Another example offer notification generated by the screen generation unit 333 has been described with reference to FIGS. 7 and 8. Next, another example offer notification generated by the screen generation unit 333 will be described with reference to FIG. 9.

FIG. 9 is an explanatory diagram for describing another example offer notification screen for a service of package collection and transportation, generated by the screen generation unit 333. FIG. 9 is a diagram illustrating a state where irregular task notification 650, irregular task notification 660, and irregular task notification 670 generated by the screen generation unit 333 are displayed on the operation display unit 150A of the service provider terminal 10A. Furthermore, the irregular task notification 650, the irregular task notification 660, and the irregular task notification 670 are examples of the irregular task information.

In the example illustrated in FIG. 9, it is understood that each of the irregular task notification 650 to the irregular task notification 670 displays information of the package collection time period, package collection point, type of task, and delivery destination in an offered irregular task that are separated by slash marks. This display allows the service provider U to take a look of overviews of irregular tasks that the service provider U can be applied for, on the operation display unit 150A.

The control unit 330 of the server 30 may determine an irregular task to be notified to the service provider terminal 10A used by the service provider U on the basis of the distance between the current position of the service provider U and the package collection point for each irregular task.

If, for example, the service provider U performs operation of two consecutive quick presses on any of the irregular task notification 650, the irregular task notification 660, and the irregular task notification 670 in the example screen illustrated in FIG. 9, the screen displayed on the operation display unit 150A may make transition to an offer notification screen indicating detailed information of each of the irregular task notification 650, the irregular task notification 660, and the irregular task notification 670.

Furthermore, if, for example, the service provider U gives one press on any of the irregular task notification 650, the irregular task notification 660, and the irregular task notification 670 in the example screen illustrated in FIG. 9, the pressed irregular task notification may be in a selected state. Furthermore if, with any of the irregular task notifications selected, operation of another press on the button B1 is performed, the service provider terminal 10A may notify the server 30 that the service provider U has applied for the irregular task in any of the irregular task notification 650, the irregular task notification 660, and the irregular task notification 670.

Another example offer notification screen for a service of package collection and transportation, generated by the screen generation unit 333 has been described with reference to FIG. 9.

### (Authentication Unit 335)

Returning to FIG. 4, description of an example functional configuration of the server 30 will be continued. The authentication unit 335 has a function to perform authentication processing in response to an authentication request received from the information terminal 10. For example, the authentication unit 335 performs package collection authentication or package handing-over authentication in response to an authentication request from the service provider terminal 10A.

To described in more detail, if the communication unit 310 receives a request of package collection authentication for a package L from the service provider terminal 10A, the authentication unit 335 performs authentication processing of determining whether the request is a request from the service provider U approved as the service provider for the package L. The authentication unit 335 refers to the database stored in the storage unit 320 to check the package ID and the service provider ID corresponding to each service provider U, thereby performing the authentication processing. If confirming that the package ID included in the authentication request and the service provider ID of the service provider U using the service provider terminal 10A are associated with each other, the authentication unit 335 determines that the request of the package collection authentication for the package L is a request from the approved service provider U. In this case, the authentication unit 335 also determines that the authentication has succeeded. On the other hand, if confirming that the package ID and the service provider ID of the service provider U are not associated with each other, the authentication unit 335 determines that the request of the package collection authentication for the package L is not authentication from the approved service provider U. In this case, the authentication unit 335 also determines that the authentication has failed.

Furthermore, the authentication unit 335 may perform authentication of the service provider U in response to an authentication request from the service provider terminal 10A based on identification information relating to the holding device 20. The identification information may be, for example, an identification code, such as a bar code and a QR code (registered trademark), printed or adhered on the exterior of or contained in the holding device 20, or identification information capable of being acquired by reading an RFID at the service provider terminal 10A and capable of uniquely identifying each holding device 20. In this case, the received identification information relating to the holding device 20 and the package ID preliminarily given to the package L held by the holding device 20 may be associated with each other. When the authentication unit 335 performs authentication on the basis of the identification information relating to the holding device 20 in this way, the identification information relating to the holding device 20 and the package ID of the package L are associated with each other and stored in the database stored in the storage unit 320 when the package L is held by the holding device 20. If confirming that the package ID of the package L associated with the identification information relating to the holding device 20 included in the authentication request and the service provider ID of the service provider U using the service provider terminal 10A are associated with each other, the authentication unit 335 determines that the authentication has succeeded.

Furthermore, upon receiving a request of package handing-over authentication for a package L from the service provider terminal 10A, the authentication unit 335 performs authentication processing on the basis of identification information received from the recipient terminal 10B used by the recipient R being the delivery destination of the package L. For example, by checking the identification information (for example, the package ID) received from the recipient terminal 10B and the service provider ID of the service provider U using the service provider terminal 10A being the source of the authentication request, the authentication unit 335 performs the authentication processing.

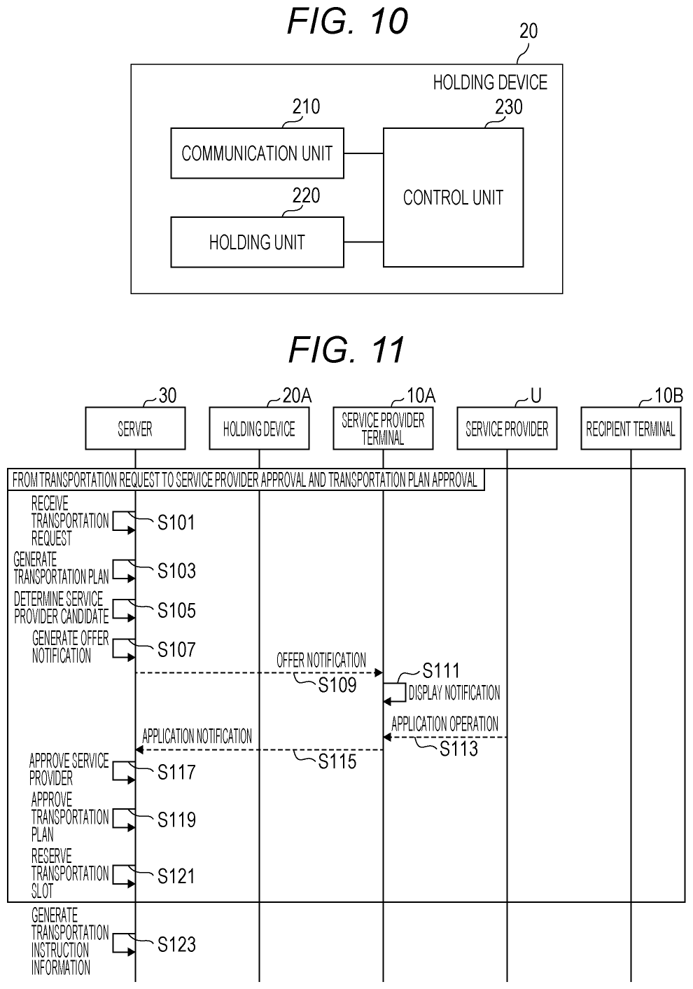

An example functional configuration of the server 30 of the present embodiment has been described with reference to FIG. 4. Next, an example functional configuration of the holding device 20 of the present embodiment will be described with reference to FIG. 10.

### <2-3. Holding Device 20>

FIG. 10 is an explanatory diagram illustrating an example internal configuration of the holding device 20 of the present embodiment. As illustrated in FIG. 10, the holding device 20 includes a communication unit 210, a holding unit 220, and a control unit 230.

### (Communication Unit 210)

The communication unit 210 communicates with the server 30 via the network. For example, the communication unit 210 receives an instruction for control of the holding unit 220 from the server 30.

### (Holding Unit 220)

The holding unit 220 holds a package L for which a recipient R is designated as the addressee. The holding unit 220 makes the package L possible to be carried away by the service provider U on the basis of the control instruction received by the communication unit 210 from the server 30. For example, the holding unit 220 may have a box shape capable of accommodating the package L and include a lid that can be opened and closed. In this case, the holding unit 220 allows the lid to be opened to make the package L possible to be carried away by the service provider U. Furthermore, the holding unit 220 may hold the package L in such a manner that a fixing object, such as a belt or a frame, fixes the package L. In this case, the holding unit 220 may allow part of the fixing object to be taken off to make the package L possible to be carried away by the service provider U. The configuration of the holding unit 220 is not limited to these examples, and it is only required to hold the package L.

### (Control Unit 230)

The control unit 230 controls overall operation of the holding device 20. For example, the control unit 230 controls the holding unit 220 so that the package L becomes possible to be carried away from the holding unit 220 in accordance with the instruction for control of the holding unit 220 received by the communication unit 210 from the server 30.

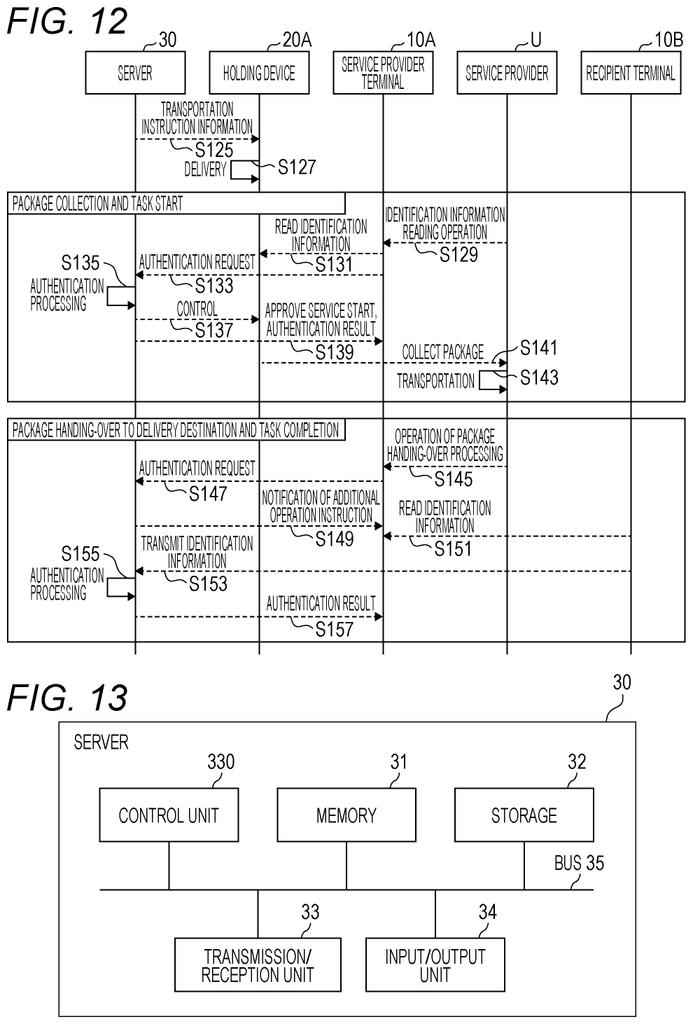

An example functional configuration of the holding device 20 of the present embodiment has been described with reference to FIG. 10. Next, example operation of the information processing system of the present embodiment will be described with reference to FIGS. 11 and 12.

### 3. Example Operation

FIG. 11 is a first sequence diagram for describing example operation of the information processing system of the present embodiment.

(Example Operation from Transportation Request to Service Provider Approval and Transportation Plan Approval)

First, the communication unit 310 of the server 30 receives a request of package delivery or collection (transportation request) (S101). If the transportation request is received, the control unit 330 of the server 30 generates transportation plans (S103). Note that, among the generated transportation plans, for example, one or more transportation plans having short total transportation time or one or more transportation plans having low total transportation charges may be stored by priority as a generated transportation plan, and the procedure may proceed to the next step. Furthermore, if it is determined that the task is an irregular task satisfying the above-described predetermined condition, a transportation plan with a combination of delivery to a deliverable point (relay point) using transportation means and package collection and transportation by a service provider U from the deliverable point to the delivery destination may be generated at step S103.

If all the transportation plans generated by the control unit 330 at S103 are plans in which, without using service providing by a service provider, package delivery is completed by another different transportation means, the processes at S123 to S127, which will be described later, are performed after the process at S103 is performed. In this case, the information processing system of the present embodiment completes a series of operations from reception of one transportation request to completion of delivery after the process at S127 is performed.

If the transportation plans generated at S103 include a transportation plan with a combination including a service of package collection and transportation by a service provider, the candidate determination unit 331 of the server 30 determines a service provider candidate (S105).

The screen generation unit 333 of the server 30 generates offer notification for the service (S107). The control unit 330 causes the communication unit 310 to transmit the offer notification to the service provider terminal 10A used by the user determined to be the service provider candidate (S109).

The control unit 130 of the service provider terminal 10A displays the offer notification received from the server 30 on the operation display unit 150 (S111). Here, if the service provider U does not perform operation of applying for the offer, the control unit 330 may change the transportation slot or the package collection point in the transportation plan, generated at S103, with a combination including a service by a service provider. Furthermore, the server 30 may repeat the processes at S105 to S109 within a predetermined limited number of times or within a predetermined time limit until any service provider candidate accepts the offer for the service in the changed transportation plan. If no service provider candidate accepts the offer within the limited number of times or within the time limit, the server 30 may select and approve another transportation plan that does not require service providing by a service provider. In this example operation, a service provider U performs operation of accepting the offer for the offer notification received by the service provider terminal 10A from the server 30 at S109.

The service provider U browses the notification displayed on the operation display unit 150A and performs operation of applying for the offer (S113). The service provider terminal 10A notifies the server 30 that the operation of accepting the offer has been performed (S115).

The control unit 330 of the server 30 approves the service provider U having accepted the offer as the service provider (S117). At this time, the control unit 330 may cause the communication unit 310 to transmit notification of determination of the service providing to the service provider terminal 10A used by the approved service provider U.

The control unit 330 of the server 30 selects and approves one transportation plan to the package collection point with a combination including collection and transportation of the package L by the service provider U on the basis of the approval of the service provider U as the service provider (S119). Then, the control unit 330 reserves a transportation slot of the transportation means designated in the transportation plan on the basis of the approved transportation plan (S121). Then, the control unit 330 generates transportation instruction information (S123). Next, the operation continues to a second sequence diagram illustrated in FIG. 12.

FIG. 12 is the second sequence diagram for describing example operation of the information processing system of the present embodiment. Subsequent to the process at S123 illustrated in FIG. 11, the control unit 330 of the server 30 causes the communication unit 310 to transmit the transportation instruction information to the holding device 20A (S125). The holding device 20A delivers the package L to the package collection point on the basis of the received transportation instruction information (S127).

### (Example Operation at the Time of Package Collection and Task Start)

Then, the service provider terminal 10A reads identification information relating to the holding device 20A on the basis of operation of the service provider U arriving at the package arrival point (S129, S131). For example, by operating a camera of the service provider terminal 10A, the service provider U may cause the service provider terminal 10A to read the identification information from an identification code printed on the exterior of the holding device 20A. Alternatively, the service provider terminal 10A may transmit identification information received from the server 30 in response to the approval of the application, to the holding device 20A by short-distance wireless communication or the like.

The service provider terminal 10A transmits an authentication request of package collection authentication to the server 30 (S133). At this time, the authentication request of the package collection authentication includes the identification information read at S131. Alternatively, if the identification information is transmitted to the holding device 20A as described above, the holding device 20A may transmit the authentication request of the package collection authentication to the server 30.

The server 30 checks the package ID associated with the identification information received from the service provider terminal 10A and the service provider ID of the service provider U using the service provider terminal 10A to perform authentication processing (S135). If the authentication succeeds, the server 30 controls the holding device 20A to make the package L possible to be carried away from the holding device 20A (S137). Furthermore, the server 30 approves start of the service providing by the service provider U and transmits the result of the authentication to the service provider terminal 10A (S139).

The service provider U collects the package L from the holding device 20A (S141). The service provider U transports the package L to the delivery destination (S143).

### (Example Operation at the Time of Package Handing-Over to Delivery Destination and Task Completion)

After transporting the package L to the delivery destination, the service provider U operates the operation display unit 150 of the service provider terminal 10A to perform operation of package handing-over processing (S145). The operation of the package handing-over processing may be, for example, operation, of the service provider U, of pressing a “package handing-over processing” button displayed on the operation display unit 150. The service provider terminal 10A makes an authentication request of package handing-over authentication to the server 30 on the basis of the operation performed (S147).

Upon receiving the authentication request of the package handing-over authentication from the service provider terminal 10A, the server 30 transmits notification of an additional operation instruction to the service provider terminal 10A (S149). The additional operation instruction may be, for example, notification like “Present the image for authentication displayed on the screen to the package recipient and request reading operation”.

A recipient R being the recipient of the package L operates the recipient terminal 10B to cause the recipient terminal 10B to read identification information displayed on the operation display unit 150 of the service provider terminal 10A (S151). The recipient terminal 10B transmits the read identification information to the server 30 (S153). The identification information may be, for example, information of the package ID of the package L acquired by reading an identification code printed on the exterior of the package L.

Upon receiving the identification information (package ID) from the recipient terminal 10B, the server 30 checks the package ID and the service provider ID of the service provider U using the service provider terminal 10A having made the authentication request of the package handing-over authentication at S147 to perform authentication processing (S155).

If the authentication succeeds, the server 30 approves completion of the service providing by the service provider U and transmits the result of the authentication to the service provider terminal 10A (S157).

### 4. Modification of Present Embodiment

Example operation of the information processing system of the present embodiment has been described with reference to FIGS. 11 and 12. The technique of the present invention is not limited to the embodiment that has been described. First, additional functions of the communication unit and the control unit among the constituents of the holding device 20 of a modification will be described.

The communication unit 210 of this modification further includes a function as an authentication communication unit capable of directly communicating with the service provider terminal 10A. The communication method used for communication with the service provider terminal 10A is not particularly limited and is, for example, short-distance wireless communication, such as Bluetooth (registered trademark), wireless LAN, and Wi-Fi. The communication unit 210 receives an authentication request including the service provider ID of the service provider U using the service provider terminal 10A, from the service provider terminal 10A.

The control unit 230 of this modification further includes a function as an authentication unit that performs authentication processing of determining whether the request of package collection authentication of a package L is a request from the service provider U approved by the server 30 as the service provider for a service of package collection and transportation of the package L. The control unit 230 stores the service provider ID of the approved service provider U capable of receiving the package L held by the holding device 20. The service provider ID may be preliminarily transmitted from the server 30 to the communication unit 210 or may be stored when the package L is held by the holding device 20.

If the stored service provider ID coincides with the service provider ID received by the communication unit 210 from the service provider terminal 10A, the control unit 230 controls the holding unit 220 to make the package L possible to be carried away from the holding unit 220.

With the information processing system of this modification, at the time of package collection authentication by the service provider U, such control is performed that the package L becomes possible to be carried away from the holding device 20 without communication between the service provider terminal 10A and the server 30. Thus, if the holding device 20 is an unmanned vehicle and even if the holding device 20A stops in a location where the service provider terminal 10A and the server 30 cannot communicate with each other, the service provider U can perform the authentication to collect the package L.

### 5. Hardware Configuration Example

The information processing described above is achieved through cooperation of software and hardware of the server 30 described below. Note that the hardware configuration described below is also applicable to the information terminal 10 and the holding device 20.

FIG. 13 is an explanatory diagram for describing an example of the hardware configuration of the server 30 according to the present embodiment. As illustrated in FIG. 12, for example, the server 30 includes a control unit 330, a memory 31, a storage 32, a transmission/reception unit 33, an input/output unit 34, and the like, which are electrically connected to each other via a bus 35.

The control unit 330 is an arithmetic device that controls the overall operation of the server 30, controls transmission and reception of data between each of the elements, executes applications, and performs information processing and the like necessary for authentication processing. For example, the control unit 330 is a CPU and/or a GPU, which executes programs and the like for the system stored in the storage 32 and expanded on the memory 31 to perform various kinds of information processing as described above.

The memory 31 includes a main memory that is configured with a volatile storage device such as dynamic random access memory (DRAM) or the like, and an auxiliary memory that is configured with a non-volatile storage device such as a flash memory, a hard disc drive (HDD), or the like. The memory 31 is used as a work area and the like of the control unit 330, and also stores the basic input/output system (BIOS) executed when starting the server 30 as well as various kinds of setting information and the like.

The storage 32 stores various kinds of programs such as application programs and the like. A database that stores the data used for each kinds of processing may be built in the storage 32.

The transmission/reception unit 33 connects the server 30 to the network and/or blockchain network. Note that the transmission/reception unit 33 may include near field communication interfaces of Bluetooth (registered trademark) and Bluetooth Low Energy (BLE).

The input/output unit 34 is an information input device such as a keyboard, a microphone, a mouse, and the like and an output device such as a display, a speaker, and the like.

The bus 35 is commonly connected to each of the above elements and transmits, for example, address signals, data signals, and various kinds of control signals.

### 6. Supplement

The preferable embodiment of the present invention is described above in detail with reference to the accompanying drawings. However, the technical scope of the present invention is not limited to such examples. It is readily apparent to those having ordinary knowledge and skilled in the art to which the present invention belongs that various modifications and substitutions can be made without departing from the technical spirit and scope of the appended claims, and that those naturally fall within the technical scope of the present invention.

For example, in the above-described embodiment, the candidate determination unit 331 determines a user estimated to be capable of providing a service as a service provider candidate on the basis of the package collection time period at the package collection point, the current position of the user, the travel means of the user, and the providing schedule status of a determined service of the user; however, the present invention is not limited to this example. For example, the candidate determination unit 331 may preliminarily acquire a service providable condition indicating a condition on which each user is capable of providing a service. A service providable condition is, for example, an area where each user can collect and transport a package, a time period in which service providing can be accepted without reception of offer notification, or the like.

In this case, the candidate determination unit 331 may immediately approve a user satisfying the service providable condition as a service provider without notifying the user determined to be the service provider candidate of an offer. At this time, the control unit 330 of the server 30 may transmit notification of determination as the service provider, from the communication unit 310 to the service provider terminal 10A. This allows the control unit 330 to immediately approve any user as a service provider without waiting for a user to accept an offer. Thus, the time taken until approval of a transportation plan generated by the control unit 330 can be further shortened. Furthermore, the service provider U can automatically apply for a task satisfying a condition on which an offer can be accepted. Thus, convenience for the service provider in a service of package collection and transportation is improved.

Furthermore, in the above-described embodiment, an example in which a service provider U mainly provides a service of package transportation from the package collection point to the delivery destination has been described. However, the present invention is not limited to this example. The service provider U may provide a service of package collection from the client of a transportation request. In this case, the service provider U may provide a service of collecting and transporting a package L from a collection position designated by the client of the transportation request to the warehouse WH or an intermediate point, such a drone stand.

Furthermore, the steps in the operation procedure of the information terminals 10, the holding device 20, and the server 30 of the present embodiment are not necessarily performed chronologically in the order described as the explanatory diagrams. For example, the steps in the operation procedure of the information terminals 10, the holding device 20, and the server 30 may be performed in order different from the order described as the explanatory diagrams or may be performed in parallel.

Furthermore, the effects described in this specification are merely explanatory or exemplary and not limiting. That is, the technique of the present invention can achieve other effects that are obvious to those skilled in the art from the description in this specification, in addition to or instead of the above-described effects.

Furthermore, a computer program for causing hardware, such as the CPU, ROM, and RAM, built in the information terminals 10, the server 30, and the holding device 20 to perform a function equivalent to each of the above-described constituents of the information terminals 10, the server 30, and the holding device 20 can be created.

### Reference Signs List

10 Information terminal
110 Communication unit
130 Control unit
150 Operation display unit
170 Position measurement unit
20 Holding device
210 Communication unit
220 Holding unit
230 Control unit
30 Server
310 Communication unit
320 Storage unit
330 Control unit
331 Candidate determination unit
333 Notification generation unit
335 Authentication unit
339 Screen generation unit

1. An information processing system comprising:
a communication unit that notifies a service provider terminal used by a service provider candidate, of an offer for a service provider in accordance with a condition on a service of collection and transportation of a package by another different transportation means, the service provider being capable of providing the service of collection and transportation of the package;
a control unit that approves a service provider candidate capable of providing the service of collection and transportation of the package as a service provider; and
a screen generation unit that generates notification of information on the collection and transportation of the package.

2. The information processing system according to claim 1, wherein
the control unit acquires position information and information on providing schedule status of a determined service of the service provider candidate, from the service provider terminal, and
the control unit determines a transmission destination of notification of the offer by the communication unit based on the position information of the service provider candidate, the providing schedule status of the service, and travel means, preliminarily stored in a storage unit, of the service provider candidate.

3. The information processing system according to claim 2, wherein the information on the service of the collection and transportation of the package includes current-position-as-origin task information being information on the service estimated, by the control unit, to be capable of being provided by the service provider candidate in accordance with at least any one or more of a distance to a package collection point with a current position of the service provider candidate being an origin, a travel route, and a travel time.

4. The information processing system according to claim 3, wherein the information on the service of the collection and transportation of the package includes determined-task-as-origin information being information on the service estimated, by the control unit, to be capable of being provided by the service provider candidate in accordance with at least any one or more of a distance to a package collection point in another service with a package collection point or a delivery destination in the determined service of the service provider being an origin, a travel route, and a travel time.

5. The information processing system according to claim 4, wherein
the control unit generates one or more transportation plans including a transportation route for the package of the other different transportation means and transportation means to the package collection point,
the control unit approves a user determined to be the service provider candidate as the service provider based on acceptance of the offer by the user, and
upon the approval of the service provider, the control unit selects and approves one transportation plan among the transportation plans.

6. The information processing system according to claim 4, wherein
the control unit acquires a service providable condition indicating a condition on which each user is capable of providing a service, and
the control unit selects a user satisfying the service providable condition among the users determined to be the candidates and approves the user as the service provider.

7. The information processing system according to claim 5, wherein the information on the service of the collection and transportation of the package includes irregular task information being information on notification, for a service provider candidate, of an offer for a service of collection and transportation of the package in a transportation section in the transportation plan generated by the control unit, transportation by the other different transportation means being planned in the transportation section.

8. The information processing system according to claim 7, wherein the irregular task information is information on notification of an offer for a service of collection and transportation of the package based on a transportation request in which time for collection or delivery is not designated by a transportation client of the package or a transportation request with a certain amount or more of time remaining from current time to designated time of delivery of the package.

9. The information processing system according to claim 8, further comprising an operation display unit that displays the notification of the offer, and receives application operation of the user for the notification of the offer.

10. The information processing system according to claim 9, further comprising an authentication unit that performs authentication processing of determining whether a request of package collection authentication being authentication of collection of the package by the service provider is a request from the service provider approved by the control unit.

11. The information processing system according to claim 10, wherein the control unit performs such control that, when the authentication unit determines that the request of the package collection authentication of the package is a request from the service provider for the package, the package becomes possible to be carried away from a holding device holding the package.

12. The information processing system according to claim 11, wherein
the holding device is an unmanned vehicle, and
when the authentication unit determines that the request of the package collection authentication of the package is a request from the approved service provider for the service of the collection and delivery of the package, the control unit performs such control that the package becomes possible to be carried away from the unmanned vehicle.

13. The information processing system according to claim 11, wherein the holding device holds the package released from an unmanned vehicle.

14. The information processing system according to claim 11, wherein the holding device includes
the authentication unit, and
an authentication communication unit that receives information on the authentication from the service provider terminal.

15. The information processing system according to claim 10, wherein
the communication unit receives identification information transmitted from the service provider terminal, and
the authentication unit performs authentication based on the identification information.

16. The information processing system according to claim 15, wherein the authentication unit performs authentication of collection of the package by the service provider in response to a request of authentication from the service provider terminal based on identification information relating to a holding device holding the package.

17. The information processing system according to claim 10, wherein, when the authentication unit performs the package collection authentication for the service provider, the control unit approves start of service providing of the collection and delivery of the package by the service provider.

18. The information processing system according to claim 17, wherein
the communication unit receives identification information transmitted from a recipient terminal used by a recipient of the package at a delivery destination of the package, and
the authentication unit performs authentication based on the identification information in response to an authentication request of handing-over of the package from the service provider terminal.

19. The information processing system according to claim 18, wherein, when the authentication unit authenticates the handing-over of the package by the service provider, the control unit approves completion of service providing of the collection and delivery of the package by the service provider and completion of delivery of the package to the delivery destination.

20. An information processing device comprising:
a communication unit that notifies a service provider terminal used by a service provider candidate, of an offer for a service provider in accordance with a condition on a service of collection and transportation of a package by another different transportation means, the service provider being capable of providing the service of collection and transportation of the package;
a control unit that approves a service provider candidate capable of providing the service of collection and transportation of the package as a service provider; and
a screen generation unit that generates notification of information on the collection and transportation of the package.

21. An information processing method executed by a computer, the information processing method comprising:
notifying a service provider terminal used by a service provider candidate, of an offer for a service provider in accordance with a condition on a service of collection and transportation of a package by another different transportation means, the service provider being capable of providing the service of collection and transportation of the package;
approving a service provider candidate capable of providing the service of collection and transportation of the package as a service provider; and
generating notification of information on the collection and transportation of the package.

22. A program causing a computer to function as an information processing device comprising:
a communication unit that notifies a service provider terminal used by a service provider candidate, of an offer for a service provider in accordance with a condition on a service of collection and transportation of a package by another different transportation means, the service provider being capable of providing the service of collection and transportation of the package;
a control unit that approves a service provider candidate capable of providing the service of collection and transportation of the package as a service provider; and
a screen generation unit that generates notification of information on the collection and transportation of the package.
